(19) United States
(12) Patent Application Publication
(10) Pub. No.: US 2005/0125086 A1
(43) Pub. Date: Jun. 9, 2005

(54) Progress management assisting device, method, and computer product

(75) Inventors: Takashi Noda, Tokyo (JP); Shoji Ida, Tokyo (JP)

Correspondence Address: FOLEY AND LARDNER;SUITE 500, 3000 K STREET NW, WASHINGTON, DC, 20007, US

(73) Assignees: PIONEER CORPORATION; PIONEER SHARED SERVICES JAPAN CORPORATION

(21) Appl. No.: 11/001,167

(22) Filed: Dec. 2, 2004

(30) Foreign Application Priority Data
Dec. 3, 2003 (JP) 2003-405221

(51) Int. Cl. G06F 17/60

(52) U.S. Cl. 700/83; 705/11

(57) ABSTRACT

An operation process information receiving unit receives information pertaining to an operation process from a user, and an operation completion information receiving unit receives from the user information pertaining to operation completion regarding when the work is completed. A progress status calculating unit calculates a progress status of the operation process based on the information pertaining to the operation process and operation completion. A display information creating unit creates display information based on the calculated progress status. A display information output unit outputs data based on the created display information.

### BACKGROUND OF THE INVENTION

1) Field of the Invention

The present invention relates to a technology for assisting progress management of labor.

2) Description of the Related Art

The field of material management in recent years has been steering towards realizing an effective supply chain management (SCM). To achieve this, reduction of procurement lead time (LT) is being accomplished by employing material procurement approaches such as a consignment approach and a vendor-managed inventory (VMI) approach. These material procurement approaches have brought about a shift in the trend from frequent small-lot deliveries to infrequent large-lot deliveries, resulting in a distinct shift from a ship-on-delivery pattern to an inventory-based pick-ship pattern. Consequently, there is an accompanying change in the labor requirement, the correct understanding of which plays an important role in SCM.

A conventional technology has been disclosed in Japanese Patent Laid-Open Publication No. 2001-159911.

However, although prediction of progress can be made to a certain extent in the conventional technology, progress cannot be adequately gauged in real time. Therefore, if there is an actual slowing down of progress, appropriate timely action cannot be taken.

### SUMMARY OF THE INVENTION

It is an object of the present invention to solve at least the problems in the conventional technology.

A progress management assisting device according to an aspect of the present invention includes an operation process information receiving unit that receives operation process information pertaining to an operation process; an operation completion information receiving unit that receives operation completion information pertaining to completion of operation each time an operation in the operation process is completed; a progress status calculating unit that calculates, based on the operation process information and the operation completion information, a progress status of the operation process; a display information creating unit that creates display information based on the progress status; and a display information output unit that outputs data based on the display information.

A progress management assisting method according to another aspect of the present invention includes receiving operation process information pertaining to an operation process; receiving operation completion information pertaining to completion of operation each time an operation in the operation process is completed; calculating a progress status of the operation process based on the operation process information and the operation completion information; creating display information based on the progress status; and outputting data based on the display information.

A computer program according to still another aspect of the present invention causes a computer to execute the above method.

A computer-readable recording medium according to still another aspect of the present invention stores therein the above computer program.

The other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram of a hardware configuration of a progress management assisting device according to an embodiment of the present invention;

FIG. 2 is a block diagram of a functional configuration of the progress management assisting device;

FIG. 3A is a table of limited man-hours, efficiency, and load man-hours for two workers;

FIG. 3B is a table of operation and time required to complete the operation;

FIG. 3C is a schematic for explaining the relationship between load man-hours, productive man-hours, and total estimated man-hours;

FIG. 4 is a flowchart of a progress management assistance method according to the embodiment;

FIG. 5 is a concept drawing of a Warehouse Management System (WMS) according to an example of the embodiment;

FIG. 6 is an explanatory drawing of the details related to a picking process of the WMS;

FIG. 7 is a flowchart of the picking process of the WMS according to the example of the embodiment;

FIG. 8 is an example of the contents of a picking data used for the WMS;

FIG. 9 is another example of the contents of the picking data used for the WMS;

FIG. 10 is still another example of the contents of the picking data used for the WMS;

FIG. 11 is still another example of the contents of the picking data used for the WMS;

FIG. 12 is still another example of the contents of the picking data used for the WMS;

FIG. 13 is still another example of the contents of the picking data used for the WMS;

FIG. 14 is still another example of the contents of the picking data used for the WMS;

FIG. 15 is still another example of the contents of the picking data used for the WMS;

FIG. 16 is still another example of the contents of the picking data used for the WMS;

FIG. 17 is an example of a display of the results of the WMS;

FIG. 18 is another example of the display of the results of the WMS;

FIG. 19 is still another example of the display of the results of the WMS;

FIG. 20 is an example of a display screen for displaying the results of the WMS;

FIG. 21 is another example of the display screen for displaying the results of the WMS; and

FIG. 22 is a flowchart for explaining how the WMS can be used.

### DETAILED DESCRIPTION

Exemplary embodiments of a progress management assisting device, method, and computer product according to the present invention are explained next with reference to the accompanying drawings.

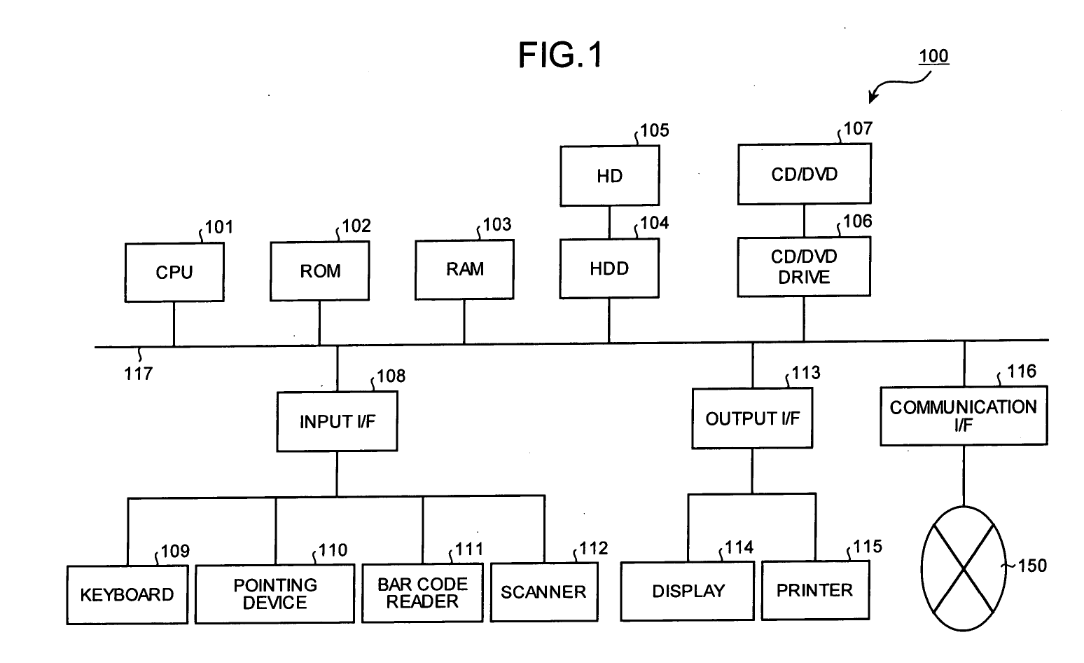

FIG. 1 is a block diagram of a hardware configuration of a progress management assisting device 100 according to an embodiment of the present invention. A central processing unit (CPU) 101 controls the progress management assisting device 100. A read only memory (ROM) 102 stores basic computer programs. A random access memory (RAM) 103 is used as a work area of the CPU 101. A hard disk drive (HDD) 104 controls reading data from and writing data to a hard disk (HD) 105 based on the control by the CPU 101. The HD 105 stores the data written based on the control by the HDD 104.

The progress management assisting device 100 further includes a compact-disk/digital versatile disk (CD/DVD) drive 106 that controls reading data from and writing data to a removable CD/DVD 107 based on the control by the CPU 101. Data is read from the CD/DVD 107 based on the control by the CD/DVD drive 106. The CD/DVD 107 is only an example of a recording medium. Any known writable disk medium may be used instead of the CD/DVD 107.

An input interface (I/F) 108 is connected to a keyboard 109 that includes a plurality of keys for entering various instructions, characters, numerals, etc. The input I/F 108 is also connected to a pointing device 110, a wired or wireless bar-code reader 111, and a scanner 112 that optically reads text and images. An output interface (I/F) 113 is connected to a display 114 and a printer 115 that prints the text and images. The display 114 may be any known display device such as a liquid crystal display or a plasma display.

A communication interface (I/F) 116 functions as an interface between a network 150 and the CPU 101. The connection between the communication I/F 116 and the network 150 may be a wired or wireless connection. All the components explained above are, directly or via some other component, connected to a bus 117.

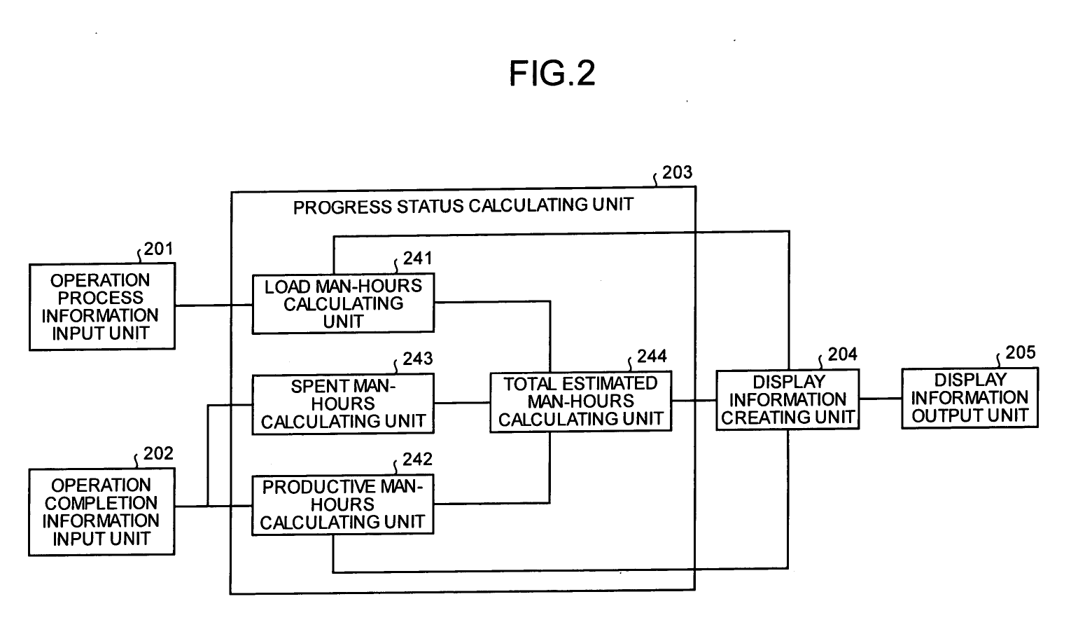

The details of the progress management assisting device 100 according to the embodiment of the present invention are explained next. FIG. 2 is a block diagram of a functional configuration of the progress management assisting device 100 according to the embodiment of the present invention. The progress management assisting device 100 includes an operation process information input unit 201, an operation completion information input unit 202, a progress status calculating unit 203, a display information creating unit 204, and a display information output unit 205.

The operation process information input unit 201 receives information pertaining to an operation process. Information pertaining to the operation process refers to the operation process of each worker. For instance, in a picking operation, the information pertaining to the operation process would be information such as the part number, shipment destination, and the number of shipments of the parts to be picked. As an example, assume there are three operations, namely, a, b, and c, and they are to be carried out in the sequence, operation a, operation b, and operation c. Then, the operation process includes management of the progress status of the operations in that sequence. If the operations a, b, and c are to be executed in no particular order, however, the operation process includes management of the progress status while any of the operations a, b, and c is being carried out. The operation process information input unit 201 realizes the function of receiving operation process information by means of the input I/F 108, the keyboard 109, the pointing device 110, the scanner 112, and/or the communication I/F 116 shown in FIG. 1.

The operation completion information input unit 202 receives information pertaining to completion of an operation every time an operation is completed. The information pertaining to completion of an operation includes information such as which operation of the entire operation process is completed, the time of completion of the operation, etc. The operation completion information input unit 202 realizes the function of receiving operation completion information by means of the input I/F 108, the bar-code reader 111, the scanner 112, and/or the communication I/F 116 shown in FIG. 1.

The progress status calculating unit 203 calculates the progress status based on the information input by the operation process information input unit 201 and the operation completion information input unit 202. The progress status includes: load man-hours, which are calculated based on the information entered by the operation process information input unit 201; productive man-hours, which are calculated based on the information entered by the operation completion information input unit 202; spent man-hours, which are calculated based on the information entered by the operation completion information input unit 202; and total estimated man-hours, which are calculated based on the load man-hours, the productive man-hours, and the spent man-hours.

The progress status calculating unit 203 includes a load man-hours calculating unit 241, a productive man-hours calculating unit 242, a spent man-hours calculating unit 243, and a total estimated man-hours calculating unit 244. The load man-hours calculating unit 241 calculates the load man-hours based on the information entered by the operation process information input unit 201. The productive man-hours calculating unit 242 calculates the productive man-hours based on the information entered by the operation completion information input unit 202. The spent man-hours calculating unit 243 calculates the spent man-hours based on the information entered by the operation completion information input unit 202. The total estimated man-hours calculating unit 244 calculates the total estimated man-hours based on the load man-hours calculated by the load man-hours calculating unit 241, the productive man-hours calculated by the productive man-hours calculating unit 242, and the spent man-hours calculated by the spent man-hours calculating unit 243.

The display information creating unit 204 creates display information of the progress status calculated by the progress status calculating unit 203. The display information creating unit 204 may, for instance, create and simultaneously display the load man-hours, productive man-hours, and the total estimated man-hours in a form of a graph. The bar graphs of the load man-hours, productive man-hours, and the total estimated man-hours, which are created as the display information by the display information creating unit 204, may be aligned at one end.

Alternatively, the bar graphs representing the load man-hours and the productive man-hours may partially overlap with each other. The bar graphs representing the productive man-hours and the total estimated man-hours may almost completely overlap with each other, the bar graph representing the productive man-hours hiding the overlapped portion of the total estimated man-hours, and the bar graphs representing the load man-hours and the productive man-hours jointly hiding the overlapped portion of the bar graph representing the total estimated man-hours. Alternatively, the edge of the load man-hours for each worker may be aligned with the scheduled completion time.

The progress status calculating unit 203 and the display information creating unit 204 perform their respective functions when the CPU 101 executes the program recorded on the ROM 102, the RAM 103, the HD 105, and the CD/DVD 107, etc., shown in FIG. 1.

The display information output unit 205 outputs the display information created by the display information creating unit 204 to a display screen of a display device which displays the information. Moreover, the display information output unit 205 can output (transmit) the display information to the display screen of another information processing device connected via the network 150. The display information output unit 205 may alternatively output the image based on the display information to a printer and allow display of the display information by printing the image on a sheet of paper. The display information output unit 205 performs its function with the aid of the output I/F 113, the display 114, the printer 115, and/or the communication I/F 116 shown in FIG. 1.

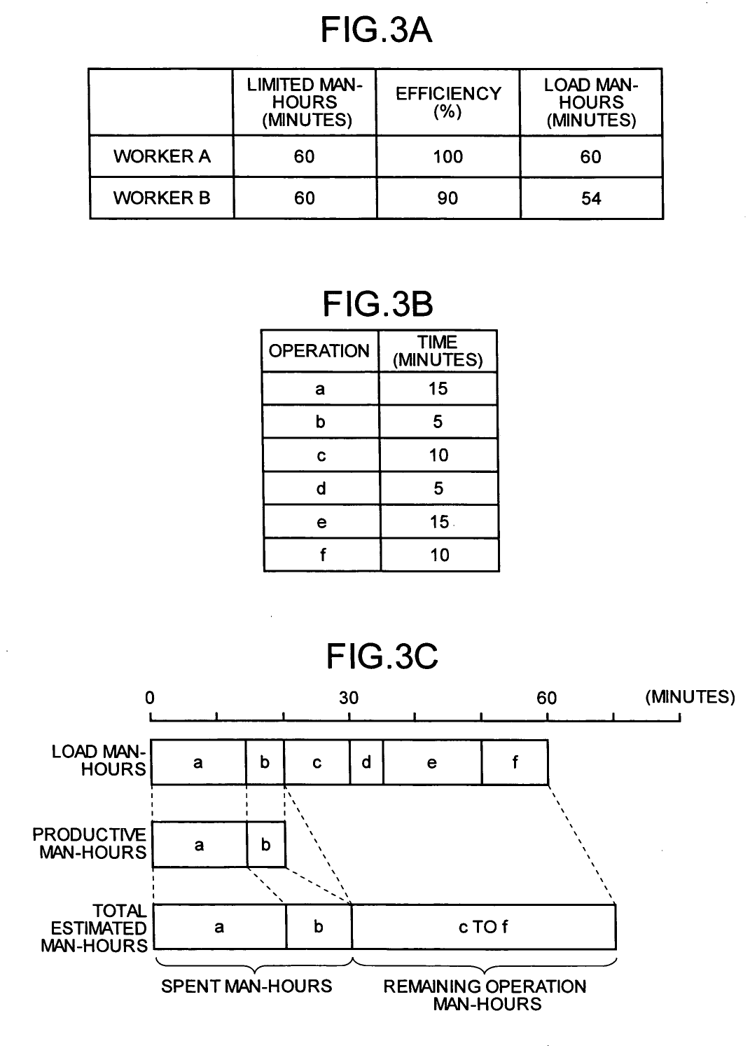

The details concerning the load man-hours, the productive man-hours, the spent man-hours, and the total estimated man-hours are explained next. FIG. 3A is a table of limited man-hours, efficiency, and load man-hours for two workers. FIG. 3B is a table of operation and time required to complete the operation. FIG. 3C is a schematic for explaining the relationship between load man-hours, productive man-hours, and total estimated man-hours.

The load man-hours is the amount of work, converted to time, expected to be completed by a worker within a predetermined period of time (limited man-hours). It is useful to consider the efficiency of the worker while calculating the load man-hours. For instance, the load man-hours for an experienced person and a novice will be different since the work completed by each of them in the same limited man-hours will be different. Generally, the load man-hours is calculated by multiplying the limited man-hours with an efficiency set based on the performance of each worker. If the limited man-hours of worker A is 60 minutes and worker A's efficiency is 100%, the load man-hours of worker A is (limited man-hours 60 minutes)×(Efficiency 1)=60 minutes. Similarly, the load man-hours of worker B is 54 minutes. As shown in FIG. 3B, the amount of work pertaining to each task (operation) converted to time is estimated beforehand, and the task (operation) that fits the estimated load man-hours is assigned to the worker. Thus, the load man-hours is also the amount of work, converted to time, that is assigned to the worker.

The productive man-hours mean the quantity of work, converted to time, that the worker actually performs. For instance, in FIGS. 3A-3C, when worker A, who has been assigned operations a through f, completes operation a and operation b, worker A's productive man-hours will be calculated as (quantity of operation a converted to time 15 minutes)+(quantity of operation b converted to time 5 minutes)=20 minutes.

The spent man-hours mean the actual time spent by a worker on a task (operation). When worker A spends 20 minutes on operation a and 10 minutes on operation b, the worker's spent man-hours will be calculated as (time spent on operation a 20 minutes)+(time spent on operation b 10 minutes)=30 minutes.

The total estimated man-hours is a time period estimated at a certain point in time, and it means how long it will take for a worker to complete all the tasks assigned to the worker. The total estimated man-hours is calculated by adding the spent man-hours and the remaining operation man-hours. The spent man-hours is calculated by the formula given earlier, and the remaining operation man-hours is calculated by subtracting the productive man-hours from the load man-hours. For instance, in FIGS. 3A-3C, at the point in time when worker A completes operations a and b, who is assigned operations a through f, the total estimated man-hours for worker A is (spent man-hours 30 minutes)+(load man-hours 60 minutes−productive man-hours 20 minutes)=70 minutes.

The remaining operation man-hours may also be calculated by using a current work efficiency represented by the spent man-hours/productive man-hours in the formula (load man-hours−productive man-hours)×(spent man-hours/productive man-hours). For instance, in FIGS. 3A-3C, the total estimated man-hours, calculated using the current work efficiency of worker A, will be (spent man-hours 30 minutes)+((load man-hours 60 minutes−productive man-hours 20 minutes)×(spent man-hours 30 minutes/productive man-hours 20 minutes))=90 minutes. However, if the above formula is applied from the beginning of the operation process, the total estimated man-hours will increase too much, since the spent man-hours in the beginning of the operation process tends to be longer. Better results can be obtained if careful consideration is given to when the formula should be applied, for example, when the formula is applied after a predetermined period has elapsed, after a predetermined amount of work has been completed, or when a task is just about to be completed.

Current performance of worker A on the task can be perceived by comparing the bar graphs of the load man-hours, productive man-hours, and total estimated man-hours shown left-aligned as shown in FIG. 3C. The current progress status (progress or delay of task) can also be perceived by comparing the load man-hours and the total estimated man-hours.

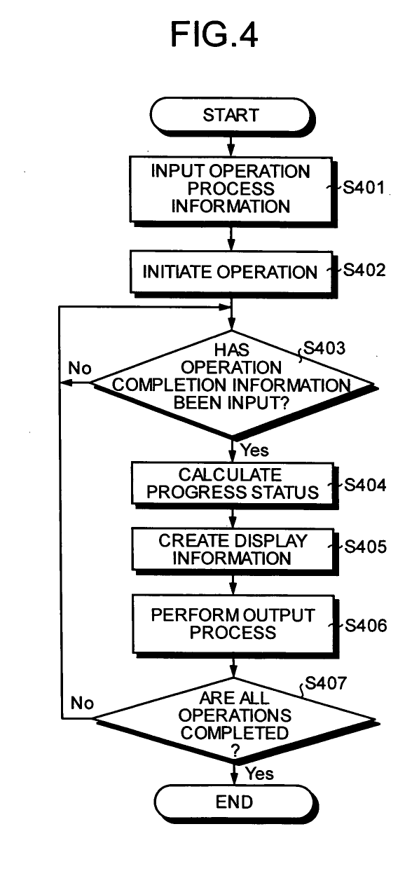

The sequence of steps of a progress management assisting method according to the embodiment of the present invention is explained next. FIG. 4 is a flowchart of a progress management assisting method according to the embodiment of the present invention. After the information pertaining to operation process has been input (Step S401), the operation is initiated (Step S402). It is assessed whether the completion information (operation completion information) pertaining to an operation has been input (Step S403). If the operation completion information has not yet been input (“No” in Step S403), the assessment of step S403 is repeated.

If the operation completion information has been input (“Yes” in Step S403), the progress status is calculated based on the operation process information that is already input in Step S401 and the operation completion information entered in Step S403 (Step S404). The progress status can be determined, for example, by calculating the load man-hours based on the operation process information, the productive man-hours based on the operation completion information, and the total estimated man-hours based on the calculated load man-hours and the productive man-hours.

The display information is created based on the progress status calculated in Step S404 (Step S405). Further, an output process (i.e., the process of transmitting to another information processing device or the printing process) or a display process is performed for the display information created in Step S405 (Step S406). The output process timing or the display process timing is described later. It is also assessed whether all the operations are completed (Step S407). If all the operations are not yet completed (“No” in Step S407), the process goes back to Step S403 and the whole process from Step S403 to Step S407 is repeated. However, if all the operations are completed (“Yes” in Step S407), the process ends.

Thus, according to the embodiment of the present invention, the operation process information input unit 201 receives information pertaining to the operation process, the operation completion information input unit 202 receives information pertaining to operation completion, the progress status calculating unit 203 calculates the progress status of the operation process based on the information input by the operation process information input unit 201 and the operation completion information input unit 202, the display information creating unit 204 creates the display information of the progress status calculated by the progress status calculating unit 203, and the display information output unit 205 outputs the display information created by the display information creating unit 204. Hence, with the completion of every operation, the progress of the operation process (operation plan) can be determined and understood in real time.

According to the embodiment of the present invention, in the progress status calculating unit 203, the load man-hours calculating unit 241 calculates the load man-hours based on the information input by the operation process information input unit 201, the productive man-hours calculating unit 242 calculates the productive man-hours based on the information input by the operation completion information input unit 202, and the total estimated man-hours calculating unit 244 calculates the total estimated man-hours based on the load man-hours and the productive man-hours calculated by the load man-hours calculating unit 241 and the productive man-hours calculating unit 242, respectively. Consequently, the progress status of the operation process (operation plan) can be clearly displayed.

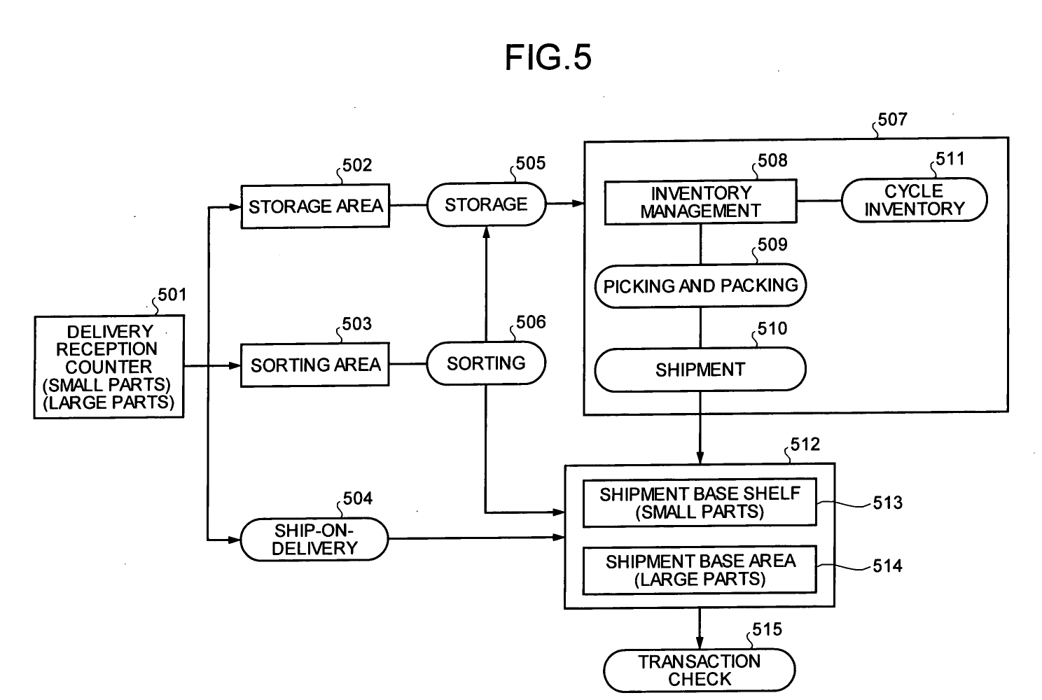

An example according to the embodiment of the present invention is explained next. FIG. 5 is a concept drawing of a Warehouse Management System (WMS) according to the example. The WMS includes a delivery reception counter 501 that receives the delivery of parts (both small parts and large parts), a storage area 502 where the delivered parts are stored, and a sorting area 503. The delivered parts are subjected to a storage process 505 in the storage area 502 and a sorting process 506 in the sorting area 503. Once the parts are subjected to the sorting process 506, they are subjected to either the storage process 505 or a shipment base process 512, whereby the parts are either relegated to a shipment base shelf (e.g., for small parts) 513 or a shipment base area (e.g., for large parts) 514.

Alternatively, the parts may be subjected to a ship-on-delivery process 504 and to the shipment base process 512, without either storing or sorting. A transaction check 515 is performed on the parts that have been subjected to the shipment base process 512. A picking process 507 is performed on the parts that are subjected to the storage process 505. The picking process 507 includes inventory management 508, a picking and packing process 509, a shipment process 510, and a cycle inventory process 511.

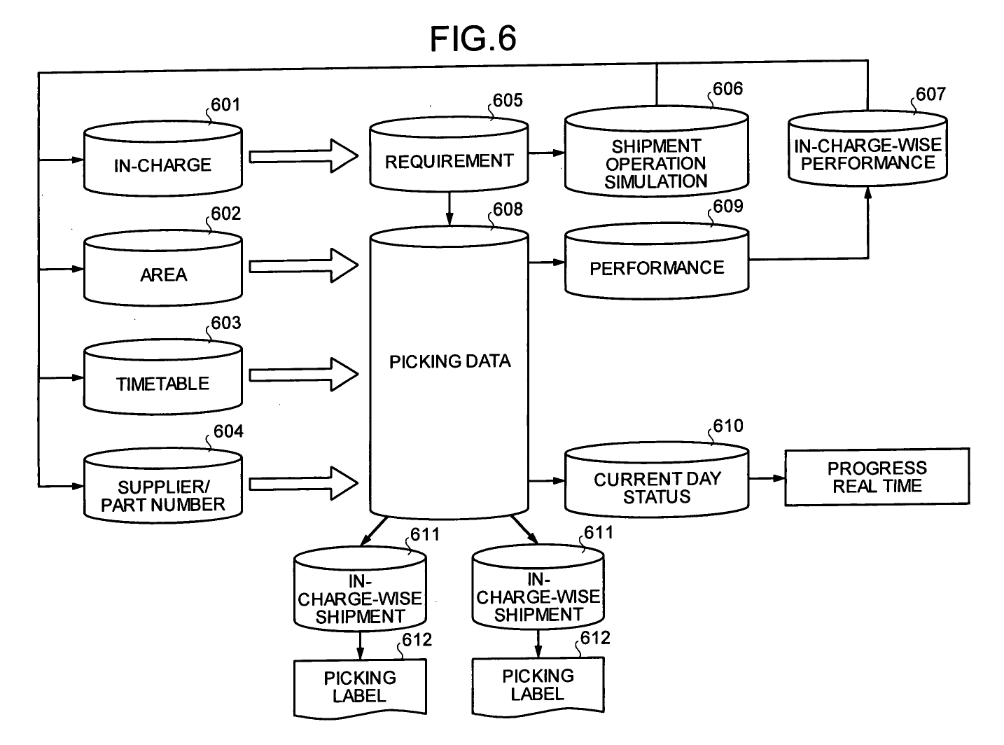

The picking process is explained next. FIG. 6 is an explanatory drawing of the details related to the picking process of the WMS according to the example of the embodiment of the present invention. The picking process includes databases that implement the picking process, namely, an in-charge database 601 pertaining to persons-in-charge, an area database 602 pertaining to the area, a timetable 603, a supplier/part number database 604 pertaining to suppliers/part numbers, and an in-charge-wise performance database 607 pertaining to in-charge-wise performance.

Upon input of current day's requirement 605, that is, information pertaining to the current day's operation process, the information is input into, through a shipment operation simulation 606, each of the databases mentioned above. At the same time, the in-charge-wise performance database 607 is also input into each of the databases mentioned above. Picking data 608 pertaining to the picking schedule is created based on the requirement 605, information pertaining to in-charge-wise man-hours output from the in-charge database 601, information pertaining to in-charge-wise shipment place range output from the area database 602, information pertaining to shipment time (formula for calculating the shipment time) according to parts shipment status output from the timetable 603, and information pertaining to classification in the timetable 603 and minimum shipment unit output from the supplier/part number database 604. The specific details of the picking data 608 created are described later.

In-charge-wise shipment information 611 pertaining to in-charge wise shipment is extracted from the picking data 608 created and a picking label 612 is created (or printed) based on the information pertaining to the in-charge-wise shipment information 611. A bar-code is printed on the printed picking label 612 and the picked and packed part is labeled with this picking label 612. A bar-code reader, such as the bar-code reader 111 shown in FIG. 1, reads the bar-code.

The in-charge-wise performance database 607 and a current day status 610 are created based on the bar-code information and the picking data 608. The in-charge-wise performance database 607 is updated as required according to the update of performance 609. A real time progress can be perceived by the current day status 610.

The picking label 612 includes, other than the bar-code, information pertaining to the part to be picked, such as the part number, the shipment destination, and the number of shipments. The person-in-charge (i.e., worker) checks the picking label 612 and picks and packs only the relevant number of parts. The picking label 612 has a seal form. The picking label 612 is pasted on the packed part, and the bar-code of the picking label 612 is read. Thus, by this series of operations related to the picking operation, mistakes in the picking operation can be reduced to a great extent, and the completion of every picking operation by each worker can be perceived in real time.

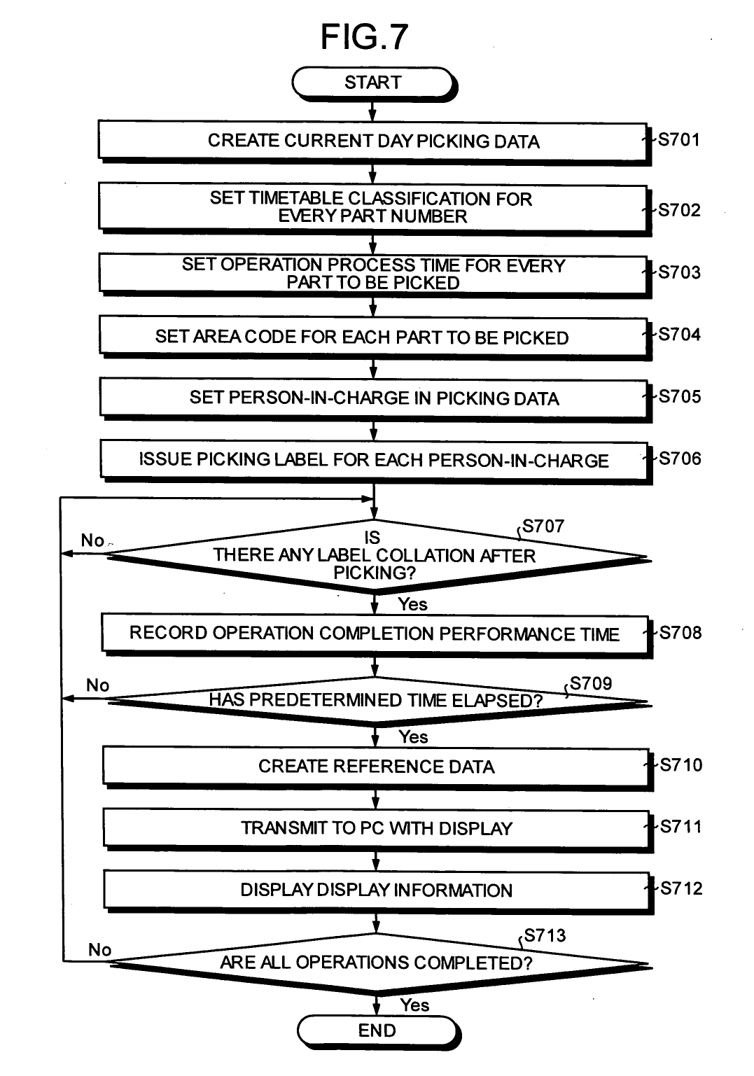

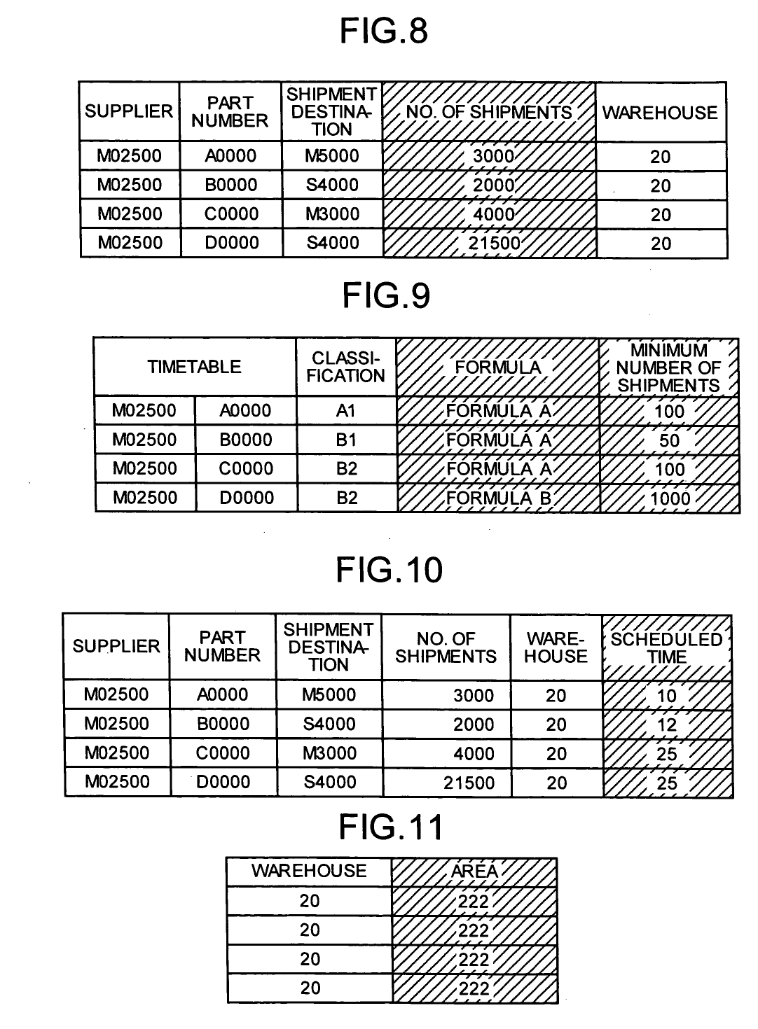

FIG. 7 is a flowchart of the picking process of the WMS according to the example of the embodiment of the present invention. FIG. 8 through FIG. 16 are the drawings of the contents of the picking data used for the WMS according to the example. The current day picking data is created (Step S701). FIG. 8 is an example of the contents of the picking data used for the WMS and illustrates a table which is created in Step S701.

A timetable classification is set for every part number of the parts to be picked (Step S702) and the scheduled time is set for every part to be picked (Step S703). FIG. 9 is another example of the contents of the picking data used for the WMS and illustrates a table in which the timetable classification and the formula are set. The timetable classification (A1, B2, etc) is already set for every supplier and part number, and the formula for every timetable classification is also registered. FIG. 10 is still another example of the contents of the picking data used for the WMS. In the table shown in FIG. 10, a field of scheduled time is added and the scheduled time of each part to be picked is set by applying the relevant formula of the timetable classification. The scheduled time is calculated by substituting the number of shipments shown in FIG. 8 in the formula (which takes into consideration the minimum number of shipments) shown in FIG. 9.

The calculation of the man-hours is classified based on whether sorting is carried out (formula A) or not (formula B). When the number of shipments is a multiple of the minimum number of shipments, no sorting is done and formula A is used. On the other hand, if the number of shipments is not in multiples of the minimum number of shipments, the fraction is sorted and formula B is used. In FIG. 9, since the number of shipments of part number “D0000” (21500 in FIG. 8) is not a multiple of the minimum number of shipments (1000 in FIG. 9), the fraction must be sorted and formula B is used while calculating the man-hours.

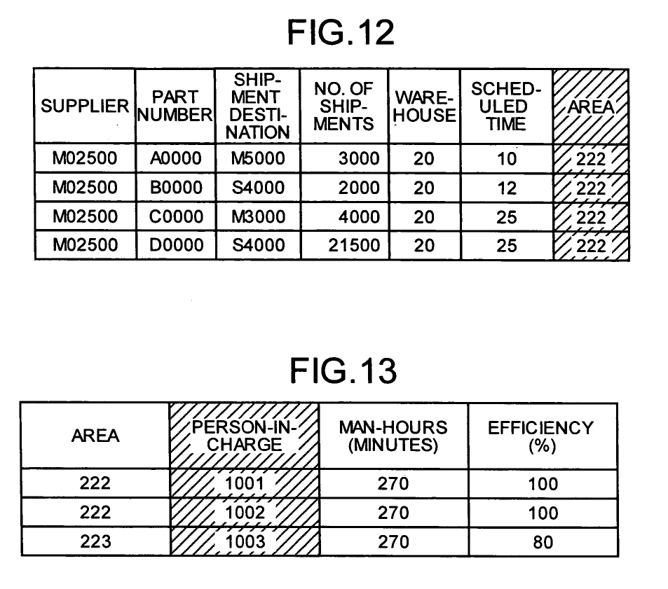

The area codes are set for each part to be picked (Step S704). For instance, using the data shown in FIG. 11, the parts to be picked are grouped into several areas according to the warehouse code and a location number (not shown) allotted to each part, and are set the area code of the relevant area. FIG. 12 illustrates a table in which the area codes are set.

Next, the persons-in-charge are set in the picking data (Step S705). FIG. 13 illustrates a table in which the person-in-charge, man-hours, and efficiency are stored by the area code, and using this data, the persons-in-charge are set one by one in the picking data in such a way that the sum of the scheduled time of the operations assigned to each worker corresponds to the worker's load man-hours. The load man-hours is calculated as limited man-hours×efficiency set based on the performance of each worker. In FIG. 13, the load man-hours of the person-in-charge “1001” is 270 (minutes)×100 (%)=270 (minutes), and the load man-hours of the person-in-charge “1003” is 270 (minutes)×80 (%)=216 (minutes).

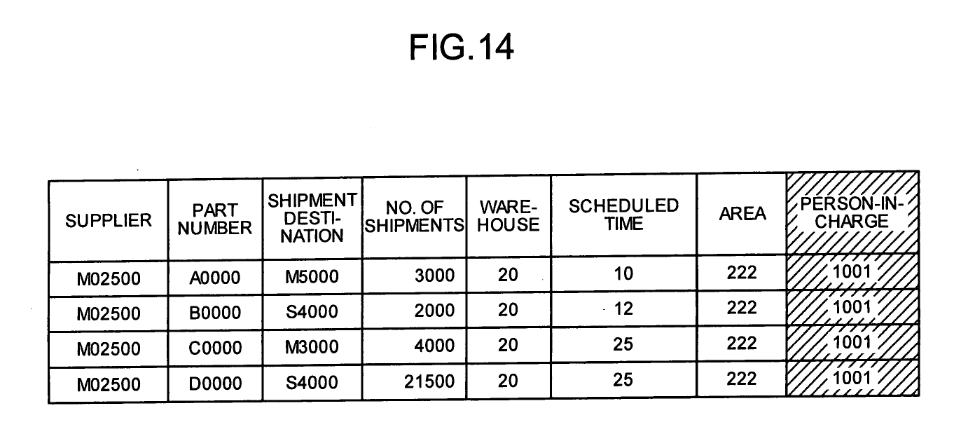

FIG. 14 illustrates a table in which the persons-in-charge are set. In FIG. 14, “the person-in-charge” of all the operations is “1001”. However, when the sum of the scheduled times of the operations assigned to the person-in-charge “1001” reaches the load man-hours (270 minutes), the next person-in-charge, i.e., “1002” is assigned to the operations thereafter. Thus, all the operations are distributed among the persons-in-charge. Picking labels are issued (printed) for each person-in-charge shown in FIG. 14 (Step S706).

It is determined whether there has been any label collation after picking for every person-in-charge (Step S707). If there is no label collation (“No” in Step S707), Step S707 is repeated. If there is label collation (“Yes” in Step S707), an operation completion performance time is recorded (Step S708). The performance time is obtained by measuring the time from the notification of the operation start until the first label collation. In the subsequent operations, performance time is obtained by measuring the time from the previous label collation until the label collation of the current operation. These measurements are separately performed for every person-in-charge.

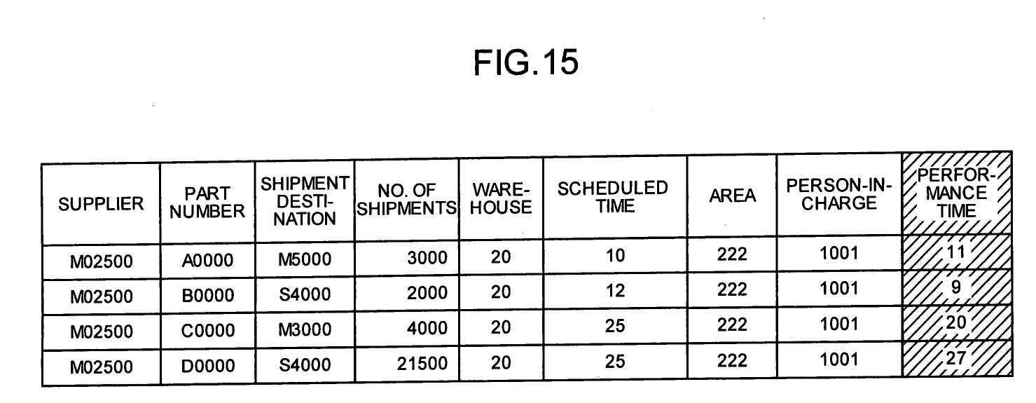

FIG. 15 illustrates a table in which performance time is recorded. The performance time “11 (minutes)” is the time from the operation start notification until the first label collation. The performance time “9 (minutes)” is the time from the first label collation until the next label collation. Thus, the time of label collation means the completion time of the current operation and the start time of the next operation. Consequently, the person-in-charge may perform label collation merely by using the bar-code reader and does not need to notify the start of or completion of the operations separately for every operation, in other words, no other operation is required to perform to notify the progress. Consequently, the person-in-charge can work more efficiently.

It is determined whether the predetermined time has elapsed (Step S709). The predetermined time may be time, such as 10 minutes, that has elapsed since the creation of a previous reference data or it may be a predetermined time, such as, every hour, every hour and 15 minutes, every hour and 30 minutes, every hour and 45 minutes, etc. The predetermined time is clocked by a clock provided in the system or in the information processing device. If the predetermined time has not elapsed (“No” in Step S709), the process returns to Step S707.

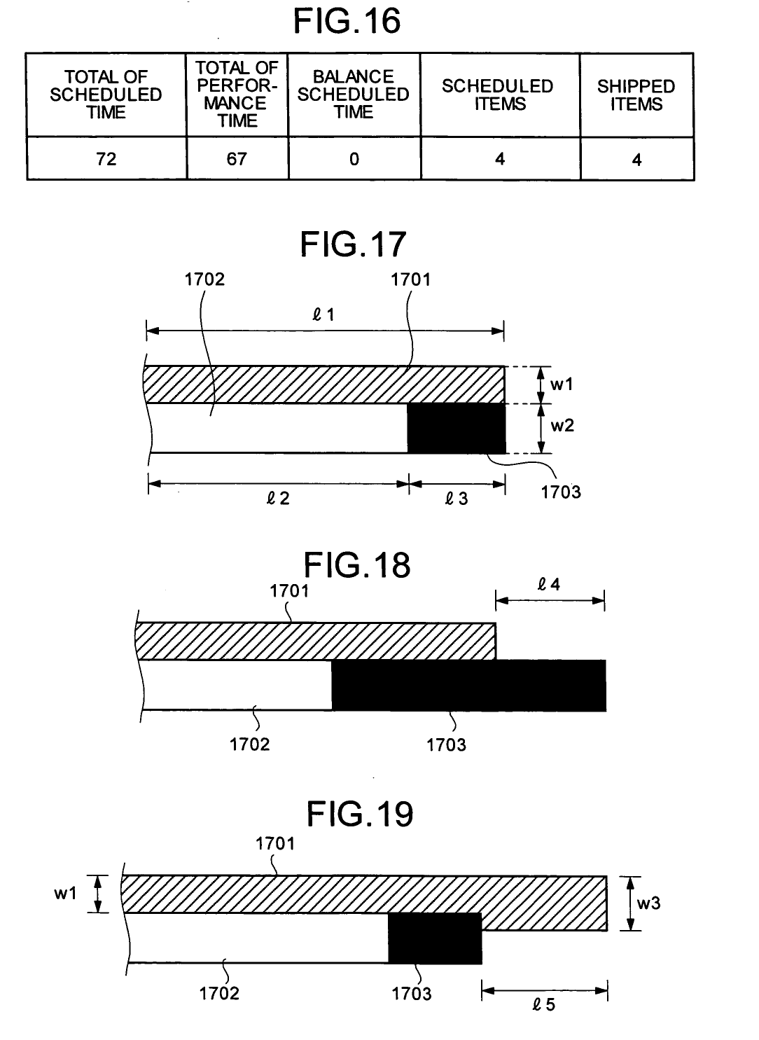

On the other hand, if the predetermined time has elapsed (“Yes” in Step S709), the reference data is created (Step S710). FIG. 16 illustrates an example of the reference data. “Total of scheduled time” is the sum of the “Scheduled time” of the completed operations shown in FIG. 15 for each person-in-charge. Similarly, “Total of performance time” is the sum of “Performance time” shown in FIG. 15 for each person-in-charge. “Balance scheduled time” is obtained by subtracting “Total of performance time” from “Total of scheduled time”. However, in FIG. 16, all the scheduled operations are completed. In other words, since “Number of scheduled items”=“4” and “Shipped items”=“4,” “Balance scheduled time” is “0.”

By taking the “Total of scheduled time” as the productive man-hours and the “Total of performance time” as the spent man-hours, the total estimated man-hours can be determined from the load man-hours, productive man-hours, and the spent man-hours using the method mentioned above. The load man-hours is determined from the limited man-hours and the efficiency and corresponds to the sum of the “Scheduled time” of all the operations allotted to one person-in-charge. A reference data such as a graph is created using man-hours mentioned above.

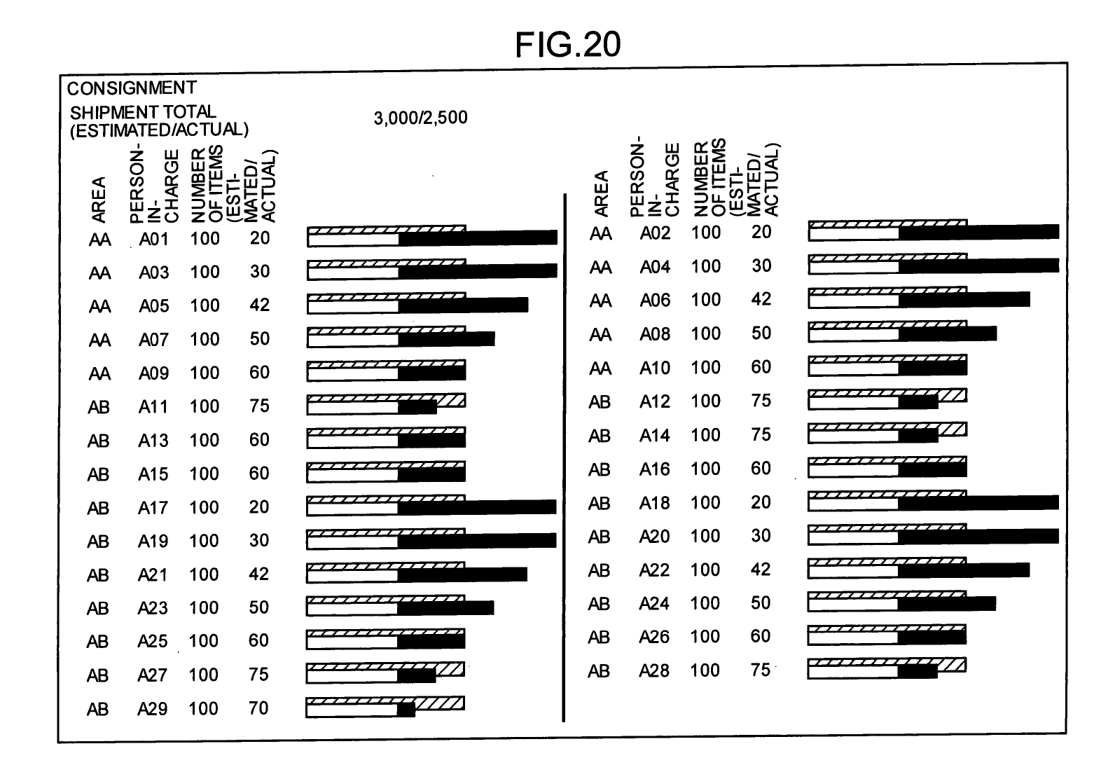

The created reference data is transmitted to a personal computer or PC (not shown) with a display (Step S711) and is displayed on the screen as shown in FIG. 20, described later (Step S712). It is determined whether all the operations by all the persons-in-charge are completed (Step S713). If the operations are not yet completed (“No” in Step S713), the process control is returned to Step S707, and the whole process from Step S707 to Step S713 is repeated. On the other hand, if all the operations are completed (“Yes” in Step S713), the process ends.

Examples of the contents of the reference data and the display screen are explained next. FIG. 17 through FIG. 19 are examples of the display of the results of the WMS according to the example of the embodiment of the present invention. Bar graph 1701 represents the load man-hours, bar graph 1702 represents the productive man-hours, and bar graph 1703 represents the total estimated man-hours.

The bar graph 1702 overlaps almost completely the bar graph 1703 with the bar graph 1702 being in the foreground. The left edges of the bar graphs 1702 and 1703 are aligned. Therefore, the actual length of the bar graph 1703, representing the total estimated man-hours, is I2+I3, with only I3 being visible. The bar graphs 1702 and 1703 jointly overlap partially with the bar graph 1701 in such a way that the bar graph 1701 is in the background with its overlapped part hidden. Consequently, in FIG. 17, the width (w1) of the bar graph 1701 is narrower than the width (w2) of the bar graphs 1702 and 1703. The bar graph 1701 having the width w1 and the bar graphs 1702 and 1703 having the width w2 may also be juxtaposed.

In FIG. 17, the load man-hours and the total estimated man-hours match. Therefore, the length of the bar graph 1701 (I1) is the same as the length of the bar graph 1703 (I2+I3). It can be learned at a glance from FIG. 17 that the operation is underway and that if it proceeds at the same pace the operation is likely to be completed as per the schedule. The performance of the operation can be determined by comparing the length (I1) of the bar graph 1701 representing the load man-hours with the length (I2) of the bar graph 1702 representing the productive man-hours.

In FIG. 18, the load man-hours and the total estimated man-hours do not match, the bar graph 1703 (I2+I3) being longer than the bar graph 1701 by (I4). It can be learned at a glance from FIG. 18 that currently the operation is underway and is behind schedule and that the operation completion time may be behind the scheduled time. The degree of delay in the operation can also be determined easily by the length (I4). The performance of the operation can be determined by comparing the length (I1) of the bar graph 1701 representing the load man-hours with the length (I2) of the bar graph 1702 representing the productive man-hours.

In FIG. 19, the load man-hours and the total estimated man-hours again do not match. However, in this example, contrary to FIG. 18, the bar graph 1703 (I2+I3) is shorter by length (I5). It can be learned at a glance from FIG. 19 that currently the operation is underway and is progressing ahead of schedule and that the operation is likely to be completed before the scheduled time. The progress of the operation can also be determined easily by the length (I5). The performance of the operation can be determined by comparing the length (I1) of the bar graph 1701 representing the load man-hours with the length (I2) of the bar graph total estimated man-hours.

Since the length (I5) of the bar graph 1701 is not overlapped by the bar graphs 1702 and 1703, the width of the length (I5) of the bar graph 1701 is (w3) instead of (w1). Thus, the progress status of an operation can be perceived by just a look at the right edge of the bar graph 1701. To be specific, a difference in the width of the bar graph 1701 at the right edge indicates that the operation is likely to end earlier than scheduled. The longer the wider portion is, the faster the operation is likely to be completed. Thus, the effect described above can be realized by creating display information in which the bar graphs 1702 and 1703, and the bar graph 1701 overlap with each other and the bar graphs 1702 and 1703 jointly hide the portion of the overlapped bar graph 1701. Further, by comparing the load man-hours and the total estimated man-hours, the width of the bar graph may be altered according to the progress status. For instance, if the total estimated man-hours is greater than the load man-hours (that is, when the operation is lagging behind), the bar graph 1703 representing the total estimated man hours may be made wider than the bar graph 1701 representing the load man-hours. Conversely, when the total estimated man-hours is less than the load man-hours (that is, when the operation is ahead of schedule), the bar graph 1703 may be made narrower than the bar graph 1701.

FIG. 20 is an example of a display screen for displaying the results of the WMS according to the example of the embodiment of the present invention. The display screen shows a shipment total (scheduled/actual). A bar graph for each person-in-charge (a total of 29 persons, from A01 through A29) is displayed according to area (area AA and area AB). Thus, the progress status of the operation for every person-in-charge can be perceived and the overall progress can be determined in a glance.

For instance, in case of the persons-in-charge “A01,” “A02,” “A03,” “A04,” etc., the lower bar graph 1703 is longer than the upper bar graph 1701, indicating that the work is behind schedule. On the other hand, in case of persons-in-charge “A11”, “A12”, “A14”, etc., the upper bar graph 1701 is longer than the lower bar graph 1703, indicating that the work is ahead of schedule. In case of persons in-charge “A09”, “A10”, “A13”, “A15”, etc., the upper bar graph 1701 and the lower bar graph 1703 are of the same length, indicating that the work is progressing as per the schedule. By comparing the bar graphs 1701 and 1702, it becomes clear that all the workers are currently working.

Each person-in-charge can easily perceive their own progress by referring to their in-charge number. On the other hand, an administrator can perceive the current progress of all the persons-in-charge at a glance. Thus, progress can be managed in real time, enabling administration of appropriate and effective service support.

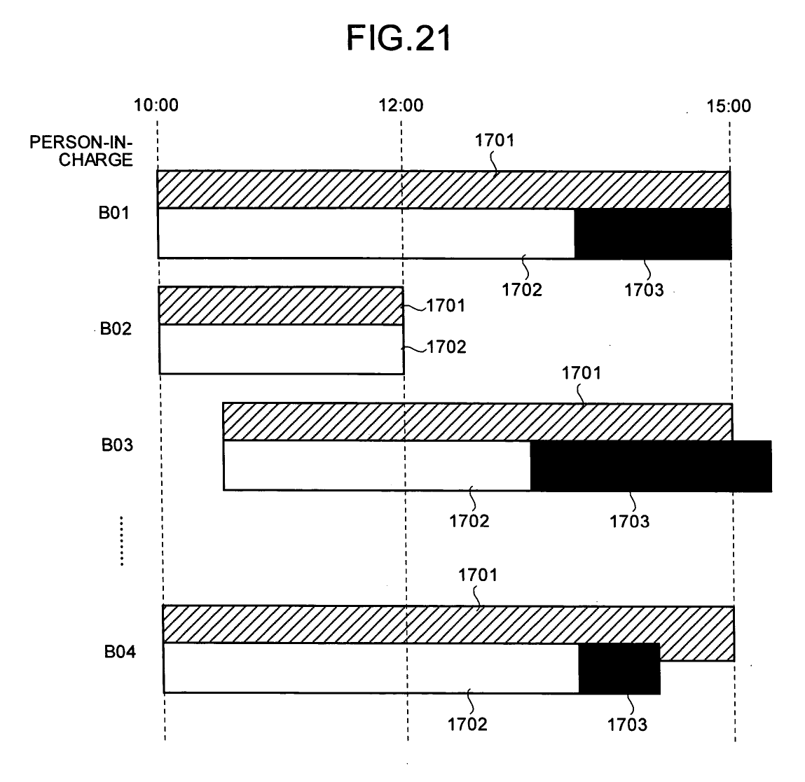

FIG. 21 is another example of the display screen for displaying the results of the WMS according to the example of the embodiment of the present invention. Since the display information is created and displayed based on the load man-hours, even if the lengths and the edges of the bar graphs 1701 of the load man-hours are the same, the completion time may differ. Thus, time axes are introduced in FIG. 21 and the ends of the bar graphs 1701 are matched to the time axis so that the completion time can be determined at a glance.

From the bar graph for the person-in-charge “B01” it can be understood that the operation has been started at 10:00 and is likely to be completed by 15:00 as per the schedule. From the bar graph for person-in-charge “B02” it can be understood that the operation was started at 10:00 and completed by 12:00. From the bar graph for person-in-charge “B03” it can be understood that the operation was started at 10.30 and, at the current pace, is likely to be behind the scheduled completion time of 15:00. From the bar graph for the person in-charge “B04” it can be understood that the operation was started at 10:00 and is likely to be completed before the scheduled completion time of 15:00.

Thus, the graphical display enables the checking of whether all the operations are being completed within the scheduled completion time. Therefore, the picking process can be completed before a predetermined shipment time.

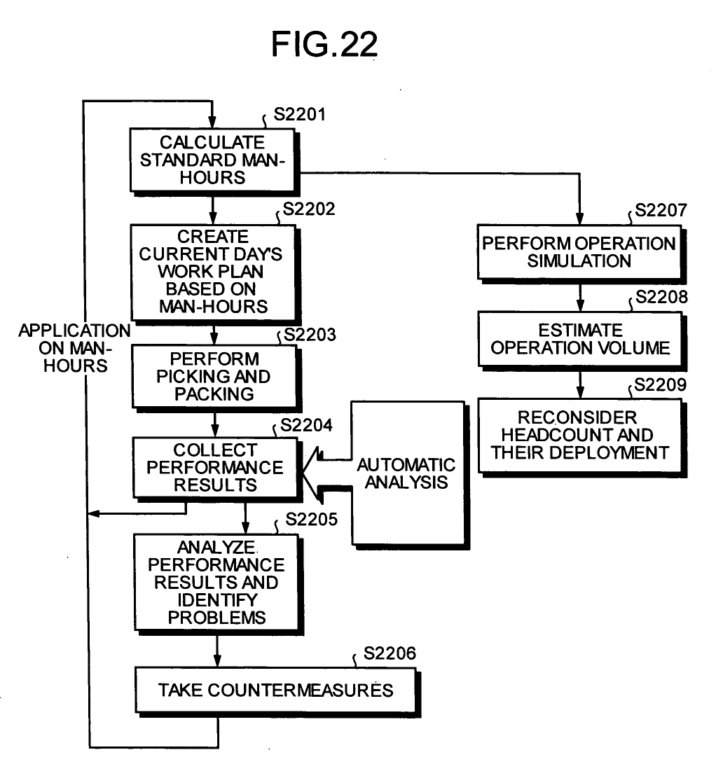

A concrete example of the workings of the WMS according to the example of the embodiment of the present invention is explained next. FIG. 22 is a flowchart for explaining how the WMS can be used according to the example. Standard man-hours are calculated for every operation (Step S2201). The current day's work plan is created based on the calculated standard man-hours (Step S2202).

The picking process (and the packing process) are performed based on the work plan (Step S2203) and the performance results are collected (Step S2204). The collection of the performance results can be automatically analyzed by reading the data with the aid of a bar-code reader. The collected performance results are applied on the man-hours. The collected performance results are analyzed and problems are identified (Step S2205). Countermeasures are taken based on the problems (Step S2206). All these details are also applied on the man-hours.

An operation simulation is performed based on the calculated standard man-hours (Step S2207), the work volume is estimated (Step S2208), and appropriate headcount and deployment is reconsidered (Step S2209). The management of progress is carried out in real time by planning the work using the standard man-hours and by collecting the performance results for the work plan. This serves as the basic data for chalking out long-term plans, and helps realize a stable and efficient operations management.

In summary, according to the embodiment of the present invention, the shipment part numbers can be verified at the time of picking by reading bar-codes. Thus, error related to picking can be reduced. Further, the performance man-hours can be measured automatically, the future load man-hours can be simulated, and work distribution and daily progress status data can be obtained based on the performance. Thus, appropriate headcount and performance efficiency can be perceived, analysis and improvement can be supported, expenses can be curtailed, and efficiency can be improved.

Since the display information is created in such a way that the load man-hours, the productive man-hours, and the total estimated man-hours are displayed simultaneously in the form of a graph, the progress can be perceived at a glance. Moreover, the progress can be referred in real time at the site, the delivery date can be strictly observed, management cycle can be shortened, and improvement can be enhanced.

The progress management assisting method according to the embodiment of the present invention may be a prepared computer readable program and performance is realized by executing the program by a computer such as a server, a personal computer and/or a workstation. This program can be recorded on a computer-readable recording medium such as a hard disk (HD), a floppy disk (FD), compact disk—read only memory (CD-ROM), a magneto optical disk (MO), a digital versatile disk (DVD), and the like. The computer executes the program by loading it from the recording medium. This program may be a transmission medium that can be distributed via a network such as the Internet.

The present document incorporates by reference the entire contents of Japanese priority document, 2003-405221 filed in Japan on Dec. 3, 2003.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A progress management assisting device comprising:
an operation process information receiving unit that receives operation process information pertaining to an operation process;
an operation completion information receiving unit that receives operation completion information pertaining to completion of operation each time an operation in the operation process is completed;
a progress status calculating unit that calculates, based on the operation process information and the operation completion information, a progress status of the operation process;
a display information creating unit that creates display information based on the progress status; and
a display information output unit that outputs data based on the display information.

2. The progress management assisting device according to claim 1, further comprising a display unit that displays the data.

3. The progress management assisting device according to claim 1, wherein the progress status calculating unit comprises:
a load man-hours calculating unit that calculates load man-hours based on the operation process information;
a productive man-hours calculating unit that calculates productive man-hours based on the operation completion information;
a spent man-hours calculating unit that calculates spent man-hours based on the operation completion information; and
a total estimated man-hours calculating unit that calculates a total estimated man-hours based on the load man-hours, the productive man-hours, and the spent man-hours.

4. The progress management assisting device according to claim 3, wherein the display information creating unit creates the display information so that, when the display information is displayed,
the load man-hours, the productive man-hours, and the total estimated man-hours can be displayed at a time in a form of a graph.

5. The progress management assisting device according to claim 4, wherein the display information creating unit creates the display information in such a manner that, when the display information is displayed,
a first bar graph, a second bar graph, and a third bar graph are aligned at a first end, wherein
the first graph represents the load man-hours, the second bar graph represents the productive man-hours, and the third bar graph represents the total estimated man-hours.

6. The progress management assisting device according to claim 5, wherein the display information creating unit creates the display information in such a manner that, when the display information is displayed,
the second bar graph overlaps on the third bar graph, the first bar graph and both the second bar graph and the third bar graph overlap partially.

7. The progress management assisting device according to claim 5, wherein the display information creating unit creates the display information in such a manner that, when the display information is displayed,
a second end of the first bar graph for every worker is aligned with a scheduled completion time.

8. A progress management assisting method comprising:
receiving operation process information pertaining to an operation process;
receiving operation completion information pertaining to completion of operation each time an operation in the operation process is completed;
calculating a progress status of the operation process based on the operation process information and the operation completion information;
creating display information based on the progress status; and
outputting data based on the display information.

9. A computer program that causes a computer to execute:
receiving operation process information pertaining to an operation process;
receiving operation completion information pertaining to completion of operation each time an operation in the operation process is completed;
calculating a progress status of the operation process based on the operation process information and the operation completion information;
creating display information based on the progress status; and
outputting data based on the display information.

10. A computer-readable recording medium that stores a computer program that causes a computer to execute:
receiving operation process information pertaining to an operation process;
receiving operation completion information pertaining to completion of operation each time an operation in the operation process is completed;
calculating a progress status of the operation process based on the operation process information and the operation completion information;
creating display information based on the progress status; and
outputting data based on the display information.
